(19) United States
(12) Patent Application Publication
(10) Pub. No.: US 2009/0052873 A1
(43) Pub. Date: Feb. 26, 2009

(54) RECORDING/PLAYBACK TERMINAL

(76) Inventors: Eiji MIYAGOSHI, Osaka (JP); Akihiro Watabe, Nara (JP); Takuya Sayama, Shiga (JP)

Correspondence Address: MCDERMOTT WILL & EMERY LLP, 600 13TH STREET, NW, WASHINGTON, DC, 20005-3096, US

(21) Appl. No.: 12/186,145

(22) Filed: Aug. 5, 2008

(30) Foreign Application Priority Data
Aug. 24, 2007 (JP) 2007-217973

(51) Int. Cl. H04N 5/00

(52) U.S. Cl. 386/126; 386/E05.001

(57) ABSTRACT

In a recording/playback terminal used for recording, on a recording medium, a plurality of target contents sent from a content server in which a plurality of contents are accumulatively stored such that each of the target contents is stored in a compressed state, a capacity determining section for determining a compression mode of each of the target contents to be recorded so that all the target contents can fit on the recording medium is provided. A content obtaining section for obtaining, from the content server, the target contents each of which is compressed in the compression mode determined by the capacity determining section is further provided. The target contents obtained by the content obtaining section are recorded on a recording medium.

### BACKGROUND OF THE INVENTION

1. Field of the Invention

The present invention relates to a recording/playback terminal for recording a content distributed from a content server via a network on a recording medium such as a DVD.

2. Description of the Prior Art

In recent years, the movement toward all IP (Internet Packet) as a NGN (Next Generation Network) has been widely discussed. Especially, a lot of discussions about the introduction of IP broadcast services using a high speed internet communication network have been held around the world.

IP broadcasting is a service for distributing contents for broadcasts and the like using an optical fiber communication network and the like. IP broadcasting has attracted the most attention as the centerpiece of triple play services which provide Internet access, telephony and TV broadcast services as a set. Specifically, in Europe, IP broadcasting is in fairly widespread. Some existing IP broadcast services provide a clipping service of clipping broadcast programs in recent three days onto a server and distributing the clipped programs (see, for example, Nomura Research Institute Information Communication Consulting, What is happening in the information/communication market?, Toyo Keizai Shinpo Sha, IT market navigator 2007 edition, p255).

For example, in France, there is a triple play service provider called “FREE”. When a user joins this service, a terminal called “Freebox”, including a modem combined with a STB (Set Top Box) is provided to the user. FREE provides Internet access via ADSL line, IP telephony and IP broadcast at 29.99 euro (about 4500 yen) per month.

As another example, FASTWEB in Italy provides an IP broadcast service as a part of triple play services. This IP broadcast service by FASTWEB is not a package service including all triple play services but an optional service of an Internet connection service.

Such IP broadcast services provide a variety of VOD (Video on Demand) contents of television channels including terrestrial broadcast channels, videos and the like as well as various additional services for video. For example, a video recording function on the network side is one of such additional services. By using this service, a user can record broadcast programs for five hours. This video recording function is a network service and, therefore, a user can perform operations, such as preset recording and like, from anywhere, as long as the user is in an environment where Internet access is available.

As another example, a storage media, such as a HDD (Hard Disc Drive) and the like, is provided on the server side and terrestrial broadcast programs in recent three days are clipped and provided. By using this service, a user can watch a broadcast program without recording the program in a recorder at home.

As described above, these services allow users to keep clipped broadcast programs in recent three days on the server side and to record broadcast programs for five hours, and are very convenient to users. However, considering that each server has a limited capacity for storing broadcast programs, it is more convenient that a user can record distributed contents in a removable disc such as a DVD (Digital Versatile Disc) or the like on the user terminal side.

If a distributed content is stored in a removable disc such as a DVD disc or the like on the user terminal side, in many cases, a codec for the distributed content is not suitable for a recording device or a recording medium on the user side and re-encoding is required. Accordingly, it takes a long time to record the content.

If an encoder and a decoder corresponding to each codec are provided for re-encoding and playback, fabrication costs are increased.

To record a desired content on a recording medium, a user have to select a recording mode such as encoding algorithm, a data compression ratio and the like by himself/herself. This reduces convenience.

### SUMMARY OF THE INVENTION

The present invention has been devised with a focus on the above-described problems. It is therefore an object of the present invention to provide an inexpensive recording/playback terminal capable of high speed recording of a plurality of contents optimally according to a capacity of a recording medium.

To solve the above-described problems, according to the present invention, a compression mode of each of the target contents to be recorded is determined to be a compression mode selected from a plurality of compression modes so that all the target contents can fit on the recording medium and the target contents each of which is compressed in the compression mode determined by the capacity determining section are received from the content server.

For example, an embodiment of the present invention is a recording/playback terminal used for recording, on a recording medium, a plurality of target contents sent from a content server in which a plurality of contents are accumulatively stored such that each of the target contents is stored in a compressed state, and is characterized by comprising: a capacity determining section for determining a compression mode of each of the target contents to be recorded to be a compression mode selected from a plurality of compression modes so that all the target contents can fit on the recording medium; a content obtaining section for obtaining, from the content server, the target contents each of which is compressed in the compression mode determined by the capacity determining section; and a content recording section for recording the target contents obtained by the content obtaining section on the recording medium.

Thus, a content to be recorded does not have to be re-coded each time. Accordingly, the content can be recorded at high speed.

Also, there is no need to provide an encoder and, accordingly, a recording/playback terminal can be fabricated with low cost.

Moreover, according to this embodiment, a compression mode of a content to be recorded is determined according to a capacity of a recording medium. Thus, the content can be recorded optimally according to the capacity of the recording medium.

### BRIEF DESCRIPTION OF THE DRAWINGS

FIG. 1 is a diagram illustrating the relationship between a recording/playback terminal 100 according to an embodiment of the present invention, a content server 200, a network 210 and a recording medium 220.

FIG. 2 is a diagram illustrating an exemplary file structure in the content server 200.

FIG. 3 is a block diagram illustrating an exemplary configuration of the recording/playback terminal 100.

FIG. 4 is a flow chart showing the operation of the recording/playback terminal 100.

### DESCRIPTION OF THE PREFERRED EMBODIMENTS

Hereafter, embodiments of the present invention will be described with reference to the accompanying drawings.

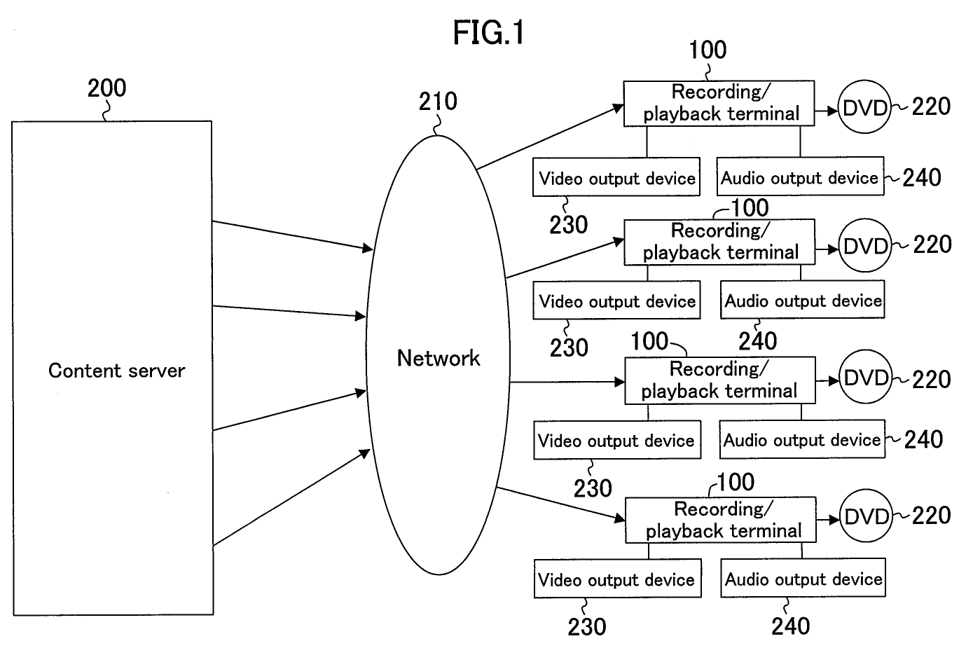

A recording/playback terminal according to an embodiment of the present invention is a device for performing playback of a content provided from a content server via a network and recording of such content on a recording medium. FIG. 1 is a diagram illustrating the relationship between a recording/playback terminal 100 according to an embodiment of the present invention, a content server 200, a network 210 and a recording medium 220 (for example, a DVD or the like).

The recording/playback terminal 100 records a content distributed by the content server 200 on the recording medium 220 in response to a request from a user. A video output device 230 for displaying a played back video and an audio output device 240 for outputting a played back audio are connected to the recording/playback terminal 100.

The content server 200 stores a plurality of contents. Specifically, for the same content (for example, a movie A), a plurality of content data coded into a plurality of different compression modes are stored in the content server 200. For example, the compression modes differ from one another due to difference in encoding algorithm. When a content includes a video, the compression modes differ from one another due to difference in resolution or frame rate. When a content includes an audio, the compression modes differ from one another due to difference in channel number or sampling frequency.

That is, in the content server 200, the same content is encoded by a plurality of different encoding algorithms. In another case, even when the same content is coded by the same encoding algorithm, the content is coded at a plurality of different resolutions and a plurality of different frame rates if the content includes a video, and is coded at a plurality of different channel numbers and a plurality of different sampling frequencies if the content includes an audio.

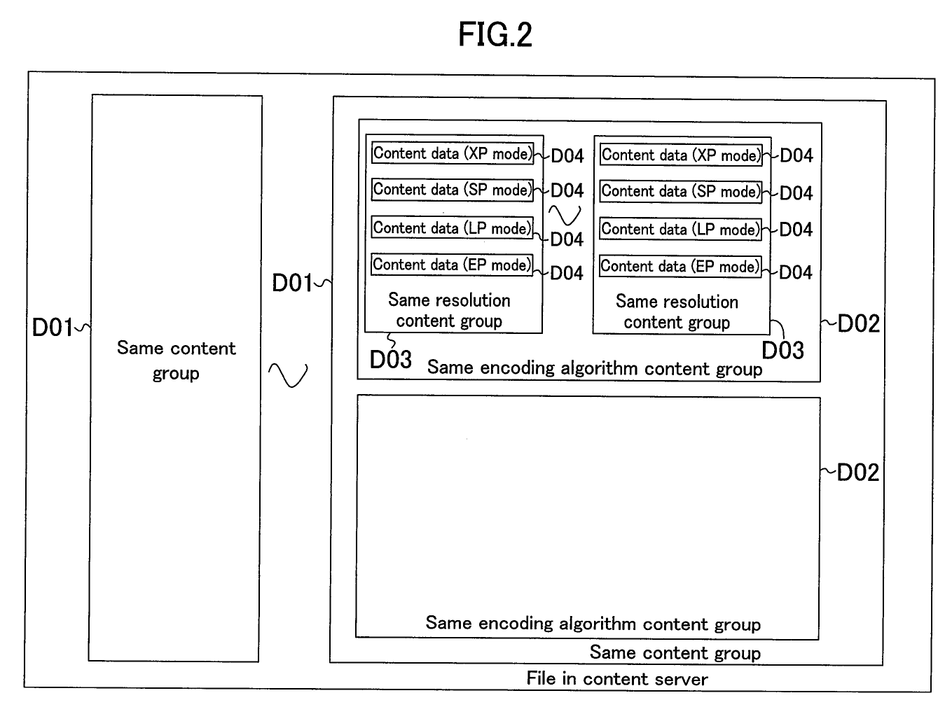

FIG. 2 is a diagram illustrating an exemplary file structure in the content server 200.

A same content group D01 denotes a collection of content data of the same content. A same encoding algorithm content group D02 in the same content group D01 denotes a collection of content data encoded by the same encoding algorithm. Each same content group D01 includes a plurality of same encoding algorithm content groups D02. That is, in the content server 200, each content is coded by a plurality of different encoding algorithms.

An encoding algorithm means a compression specification defined by a specification. Specifically, compression specifications such as MPEG (Moving Picture Experts Group) 2, MPEG 4 and the like are examples of encoding algorithms.

A same resolution content group D03 in the same encoding algorithm content group D02 denotes a collection of content data having the same resolution and the same frame rate if the content includes a video, and denotes a collection of content data having the same channel number and the same sampling frequency if the content includes an audio.

The standard definition (SD) resolution and the high definition (HD) resolution, which are typical resolutions of analog broadcasting in Japan, and the like are examples of the resolution of a video. Note that there are various formats of the high definition (HD) resolution. The followings are typical examples of HD resolutions:

1920×1080 HD (50i, 60i, and 24p)

1440×1080 HD (50i, 60i, and 24p)

1280×720 HD (50p, 60p, and 24p)

In the above-described resolutions, a vertical resolution is indicated at the left of “×” and a horizontal resolution is indicated at the right of the “×”. In parentheses, “i” denotes interlace, “p” denotes progressive and each numeric character before “i” or “p” denotes the number of frames displayed per second.

The channel number of an audio means, for example, 1 channel (monaural broadcast) or 2 channel (stereo broadcast) in the analog broadcasting in Japan. In the recent digital broadcasting, channel numbers are 5.1 channel, 7.1 channel and like surround sounds channels.

A sampling frequency is a frequency at which an audio is digitalized. There are different sampling frequencies such as 48 kHz, 96 kHz, 192 kHz and the like.

A plurality of content data D04 in the same resolution content group D03 denote content data having different compression ratios. That is, in the content server 200, contents having the same resolution, the same frame rate, the same channel number and the same sampling frequency are stored as a plurality of content data having different compression ratios.

Examples of compression ratios include XP mode, SP mode, LP mode and EP mode. These modes are the most generally used in DVD recorders for receiving an analog broadcast, which are currently commercially available in Japan. Of these examples, the XP mode has the highest bit rate and thus provides the highest quality image. The SP mode has the second highest bit rate and the LP mode and the EP mode follow in this order. In this embodiment, only 4 modes are described as examples of compression ratios. However, more levels may be provided to indicate types of compression ratios.

Note that information for contents, the compression ratio of each content, the encoding algorithm to which each content corresponds, the resolution and the frame rate type (in the case of video data), the channel number and the sampling frequency (in the case of audio data) and the like in the content server 200 is distributed from the content server 200 to the recording/playback terminal 100 before performing recording and playback.

(Configuration of Recording/Playback Terminal 100)

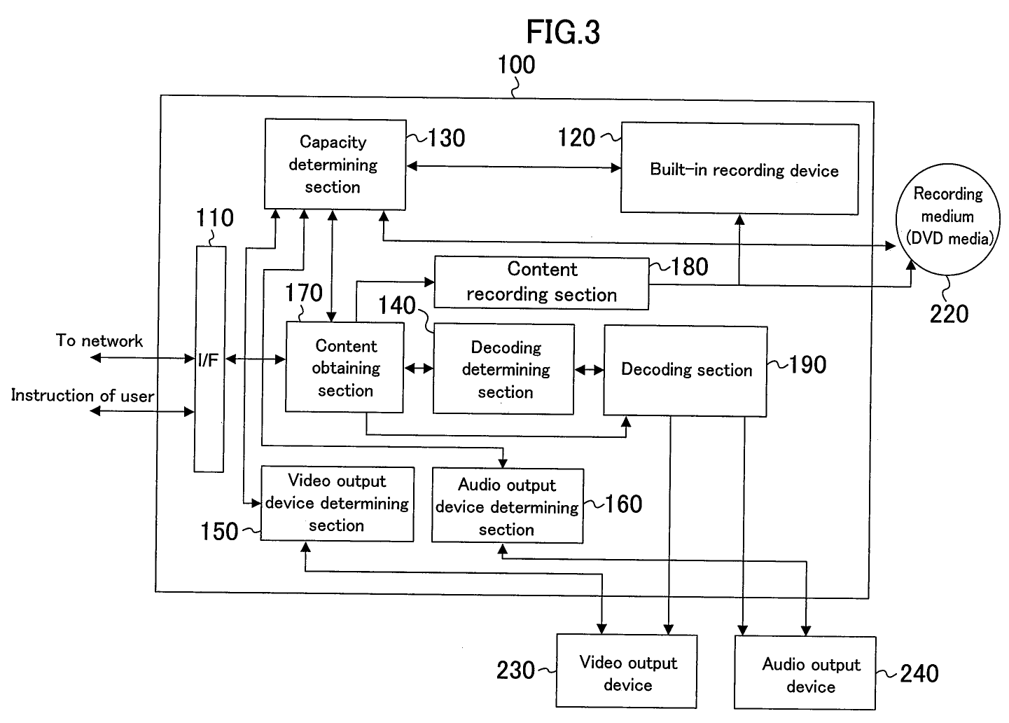

FIG. 3 is a block diagram illustrating an exemplary configuration of the recording/playback terminal 100. As shown in FIG. 3, the recording/playback terminal 100 includes an interface section 110 (which is referred to as “I/F section” in FIG. 3), a built-in recording device 120, a capacity determining section 130, a decoding determining section 140, a video output device determining section 150, an audio output device determining section 160, a content obtaining section 170, a content recording section 180 and a decoding section 190.

The interface section 110 includes a network interface for exchanging data with the content server 200 via a network and a user interface for interaction by a user. The user uses the user interface to indicate a content to be recorded on a recording medium and the like.

The built-in recording device 120 is a recording medium for recording a content, which is provided in the recording/playback terminal 100. As the built-in recording device 120, for example, a hard disk, a build-in flash memory or the like can be adopted.

The capacity determining section 130 determines a compression mode of each of target contents to be recorded so that all the target contents to be recorded can fit on the recording medium 220 (steps for determining the compression mode will be described later).

The decoding determining section 140 determines an encoding algorithm for which decoding the decoding section 190 can perform decoding.

The video output device determining section 150 determines a resolution and a frame rate at which the video output device 230 can display a video.

The audio output device determining section 160 determines a channel number and a sampling frequency at which the audio output device 240 can output an audio.

The content obtaining section 170 obtains a content according to the determination of the capacity determining section 130.

The content recording section 180 records a content obtained by the content obtaining section 170 on the recording medium 220 or the built-in recording device 120. The user instructs the recording/playback terminal 100, for example, via the interface section 110, on which the recording medium 220 or the built-in recording device 120 the obtained data is to be recorded.

The decoding section 190 decodes the content obtained by the content obtaining section 170 and outputs the decoded video and audio to the video output device 230 and the audio output device 240. The decoding section 190 does not have to include a decoder corresponding to each encoding algorithm. For example, the decoding section 190 may be formed to be able to perform decoding according to one of encoding algorithms adopted respectively for contents in the content server 200.

(Operation of Recording/Playback Terminal 100)

(1) Recording of Content on Recording Medium 220

First, the operation when a content is recorded in the recording medium 220 will be described. A content is recorded on the recording medium 220 in a format in which the content can be played back by the recording/playback terminal 100, i.e., the content can be decoded by the decoding section 190.

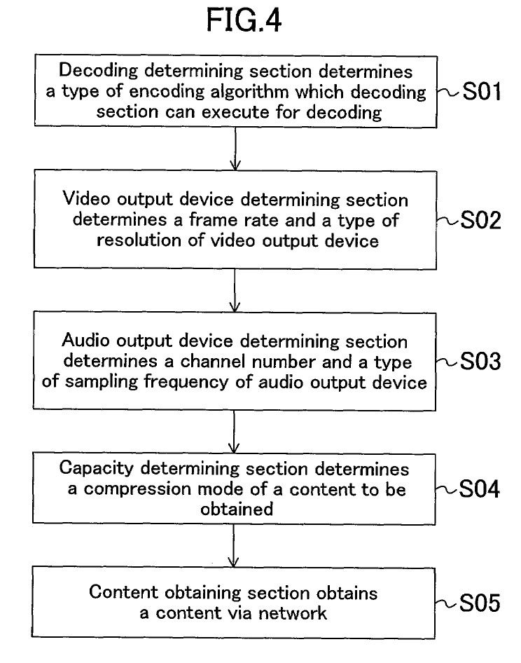

FIG. 4 is a flow chart showing the operation of the recording/playback terminal 100. In the recording/playback terminal 100, as shown in FIG. 4, in Step S01, the decoding determining section 140 determines a type of encoding algorithm which the decoding section 190 can execute for decoding. In this embodiment, for example, it is supposed that decoding according to MPEG 2 can be performed.

Next, in Step S02, the video output device determining section 150 determines a frame rate and a type of resolution at which the video output device 230 can output a video. In Step S03, the audio output device determining section 160 determines a channel number and a type of sampling frequency at which the audio output device 240 can output an audio.

In Step S04, the capacity determining section 130 determines a compression mode of each content to be recorded on the recording medium 220.

That is, a compression mode suitable for recording data on the recording medium 220 is selected from a plurality of content data which are encoded by encoding algorithms determined by the decoding determining section 140 as an algorithm which can be executed and correspond to the display resolution and frame rate at which the video output device 230 can display a video and the channel number and the sampling frequency at which the audio output device 240 can output an audio.

Note that in the case where a content recorded in the recording medium 220 does not have to be played back by the recording/playback terminal 100 itself, a compression rate of the content used where the content is recorded using an algorithm (for example, is MPEG 4) other than the algorithm determined by the decoding determining section 140 may be determined to be the suitable compression rate for recording.

In this embodiment, for example, suppose that the recording medium 220 is a DVD having a recording capacity of 4.7 Gbytes and a user selects 4 contents via the interface section 110 and records the 4 contents on the recording medium 220. Suppose further that each of the 4 contents is 1 hour program which has been recorded and encoded by MPEG 2 and the 4 contents are recorded in the XP mode, SP mode, LP mode and EP mode, respectively.

In this case, each 1 hour content encoded by MPEG 2 requires 4.6 Gbytes in the XP mode, 2.3 Gbytes in the SP mode, 1.15 Gbytes in the LP mode and 0.575 Gbyte in the EP mode.

The capacity determining section 130 selects a pattern in which a total data capacity recorded on a DVD is 4.7 Gbytes or less which is a recording capacity of the DVD. For example, if the LP mode is selected for each of the 4 contents, a necessary capacity for recording all the 4 contents by encoding by the algorithm of MPEG 2 is 4.7 Gbytes or less.

Besides the above-described selection, for example, each of the 4 contents may be recorded in the EP mode. As another option, if the user only wants to keep the quality of one of the 4 contents at high level, the one of contents is recorded in the SP mode and other three are recorded in the EP mode.

Next, in Step S05, based on a determination result in the capacity determining section 130, content data corresponding to the determined type of encoding algorithm, resolution, type of frame rate, channel number, type of sampling frequency and compression mode is obtained for each of the 4 contents. In this case, each of the obtained contents may be recorded in the same format as that when being downloaded. That is, each of the obtained contents does not have to be re-coded. This allows high speed recording.

(2) Playback of Contents

To play back contents distributed from the content server 200 via the network 210, the decoding determining section 140 first determines a type of encoding algorithm which the decoding section 190 can execute for decoding. The video output device determining section 150 determines a frame rate and a type of resolution at which the video output device 230 can output a video. The audio output device determining section 160 determines a channel number and a type of sampling frequency at which the audio output device 240 can output an audio. Based on the determination results, content data of which the encoding algorithm, the resolution, the type of frame rate, the channel number, the sampling frequency and the compression ratio are suitable for the decoding determining section 140, the video output device 230 and the audio output device 240 are obtained from the content server 200. Each of the obtained contents is decoded by the decoding section 190 and then output to the video output device 230 and the audio output device 240.

As has been described, according to this embodiment, a content to be recorded does not have to be re-coded each time, so that the content can be recorded at high speed. Moreover, there is no need to provide an encoder and, accordingly, a recording/playback terminal can be fabricated with low cost.

Moreover, according to this embodiment, a compression mode of a content to be recorded is determined according to a capacity of the recording medium 220. Thus, the content can be recorded optimally according to the capacity of the recording medium.

The decoding determining section 140 may be formed so as to determine, as a type of algorithm, one of encoding algorithms adopted respectively for contents in the content server 200. That is, the decoding determining section 140 does not have to include a decoder corresponding to each encoding algorithm. Therefore, a recording/playback terminal can be fabricated with low cost.

In this embodiment, it is supposed that the content server 200 includes a plurality of content data which have been coded in various different formats in advance. However, content data may be coded when being sent to the recording/playback terminal 100. In such case, the speed at which data is transferred from the content server 200 to the recording/playback terminal 100 depends on the ability of an encoder of the content server 200. Therefore, when high speed data transfer is desired, as in this embodiment, the content server 200 preferably includes contents which have been coded in advance.

The recording medium 220 is not limited to the DVD described in this embodiment, as long as the content server 200 is a removable media capable of accumulatively storing contents. For example, the recording medium 220 may be a semiconductor memory such as a BD (Blu-ray Disc) and a SD memory, hard disk or the like.

In this embodiment, it is also supposed that information for stored contents is given from the content server 200 to the recording/playback terminal 100 in advance and a user on the recording/playback terminal 100 side selects a content from the contents stored in the content server 200. However, in contrast to this, an encoding algorithm of a content which can be played back and information for the video output device 230 and the audio output device 240 which the recording/playback terminal 100 includes may be sent to the content server 200 from the recording/playback terminal 100 so that a suitable content for recoding the content onto the recording medium 220 are sent from the content server 200 side.

As has been described, a recording/playback terminal according to the present invention is capable of high speed recording of a plurality of contents optimally according to a capacity of a recording medium and can be fabricated at low cost. Therefore, an invention recording/playback terminal is useful as a recording/playback terminal or the like for recording a content distributed from a content server via a network on a recording medium such as a DVD.

What is claimed is:

1. A recording/playback terminal used for recording, on a recording medium, a plurality of target contents sent from a content server in which a plurality of contents are accumulatively stored such that each of the target contents is stored in a compressed state, the recording/playback terminal comprising:
a capacity determining section for determining a compression mode of each of the target contents to be recorded to be a compression mode selected from a plurality of compression modes so that all the target contents can fit on the recording medium;
a content obtaining section for obtaining, from the content server, the target contents each of which is compressed in the compression mode determined by the capacity determining section; and
a content recording section for recording the target contents obtained by the content obtaining section on the recording medium.

2. The recording/playback terminal of claim 1, wherein each of the target contents includes a video,
the plurality of compression modes differ from one another due to a difference in at least one of a resolution and a frame rate, and
the capacity determining section determines a compression mode of each of the target contents to be a compression mode corresponding to a resolution and a frame rate of a display device for displaying the video.

3. The recording/playback terminal of claim 1, wherein each of the target contents includes an audio,
the plurality of compression modes differ from one another due to a difference in at least one of a channel number and a sampling frequency, and
the capacity determining section determines a compression mode of each of the target contents to be a compression mode corresponding to a channel number and a sampling frequency of an audio output device for outputting the audio.

4. The recording/playback terminal of claim 1, further comprising a decoding section for decoding the contents recorded in the recording medium and the contents sent from the content server,
wherein the plurality of compression modes differ from one another due to a difference in encoding algorithm, and
the capacity determining section determines a compression mode of each of the target contents to be a compression mode corresponding to an encoding algorithm of the decoder.
